(19) United States
(12) Patent Application Publication
(10) Pub. No.: US 2026/0309223 A1
(43) Pub. Date: Oct. 8, 2026

(54) MOTOR VEHICLE DRIVE UNIT AND ELECTRICALLY DRIVEN MOTOR VEHICLE DRIVE AXLE

(71) Applicant: ZF Friedrichshafen AG, Friedrichshafen (DE)

(72) Inventors: Alexander Thorwart, Langenargen (DE); Michael Preuß, Friedrichshafen (DE); Rafal Woskowiak, WROCLAW (PL)

(73) Assignee: ZF Friedrichshafen AG, Friedrichshafen (DE)

(21) Appl. No.: 19/638,829

(22) Filed: Apr. 3, 2026

(30) Foreign Application Priority Data
Apr. 8, 2025 (DE) 10 2025 113 713.7

(51) Int. Cl. F16H 57/04; B60K 11/02; H02K 7/116; H02K 9/193

(52) U.S. Cl. CPC F16H 57/0476; B60K 11/02; F16H 57/0404; F16H 57/0415; F16H 57/0421; F16H 57/0436; F16H 57/045; F16H 57/0483; H02K 7/116; H02K 9/193

(57) ABSTRACT

A motor vehicle drive unit has an electric machine, a transmission, and a supply circuit to jointly supply the electric machine and the transmission with lubricant and/or coolant. The supply circuit has a first collecting region and a second collecting region. A suction side of a conveying device opens to the second collecting region. The first collecting region is below the transmission so that during operation, the first collecting region collects at least one partial return flow, which flows off after being supplied from the transmission. The second collecting region is below the electric machine and above the first collecting region. During operation the second collecting region collects at least one partial return flow, which flows off after being supplied from the electric machine. The first and second collecting regions are connected so that lubricant and/or coolant can be discharged from the second collecting region into the first collecting region.

### RELATED APPLICATIONS

This application claims the benefit of and right of priority under 35 U.S.C. § 119 to German Patent Application no. 10 2025 113 713.7, filed on 8 Apr. 2025, the contents of which are incorporated herein by reference in its entirety.

### FIELD OF THE DISCLOSURE

The invention relates to a motor vehicle drive unit, in particular, for an electrically drivable motor vehicle drive axle, comprising an electric machine and a transmission arranged downstream of the electric machine on the output side, wherein a supply circuit is assigned to the electric machine and the transmission, in which the electric machine and the transmission are jointly suppliable with lubricant and/or coolant, wherein the supply circuit comprises a first collecting region and a second collecting region, of which, in the first collecting region, a suction side of a conveying device opens, via which lubricant and/or coolant is withdrawable from the first collecting region for supply to the electric machine and the transmission. Furthermore, the invention relates to an electrically drivable motor vehicle drive axle having an aforementioned motor vehicle drive unit.

### BACKGROUND

In electrically drivable motor vehicle drive axles, in addition to lubrication and cooling of mechanical components, such as a respective transmission, cooling of a respective electric machine is also usually to be carried out. For this purpose, the respective electric machine is usually integrated into a supply circuit in which liquid lubricant and coolant, typically in the form of oil, may be guided to a stator and to a rotor of the electric machine in order to achieve cooling there in each case and thereby enable effective operation of the electric machine. Frequently, the electric machine and the respective transmission are jointly supplied in the respective supply circuit. Typically, motor vehicle drive axles require a compact construction, for which reason an aforementioned common supply circuit for an electric machine and a transmission is, in part, equipped with a plurality of collecting regions, in order, on the one hand, to enable sufficient lubrication and cooling of the electric machine and the transmission, and, on the other hand, in particular, to be able to keep an overall height of the respective motor vehicle drive axle low.

DE 10 2022 113 288 A1 discloses a motor vehicle drive unit of a motor vehicle drive axle. This motor vehicle drive unit comprises an electric machine and a transmission arranged downstream of the electric machine on the output side. The electric machine and the transmission are integrated into a supply circuit in which a common supply of the electric machine and of the transmission with lubricant and/or coolant takes place. The supply circuit is equipped with two collecting regions, of which, in the first collecting region, a suction side of a conveying device opens. In operation of the motor vehicle drive unit, lubricant and/or coolant may be drawn from the first collecting region via a pump of this conveying device and conveyed into a main supply line, from which supply of lubricant and/or coolant to the electric machine initially takes place and subsequently to regions of the transmission to be supplied. The second collecting region is arranged below the electric machine and the transmission in a direction of gravity and in a horizontal direction so as to overlap with the transmission and the electric machine, as a result of which lubricant and/or coolant flowing off after a supply from the electric machine and the transmission collects in the second collecting region.

In this context, the second collecting region is arranged horizontally next to the first collecting region and is configured to be vertically compact, in order to achieve a compact construction of the motor vehicle drive unit in the region of the transmission and the electric machine. The conveying device is equipped with a further pump via which the lubricant and/or coolant accumulating in the second collecting region may be transferred into the first collecting region.

### SUMMARY

Proceeding from the prior art described above, it is now the object of the present invention to provide a motor vehicle drive unit in which, with a compact construction and with the lowest possible manufacturing effort, a reliable supply of an electric machine and a transmission with lubricant and/or coolant in a supply circuit is to be achieved.

This object is achieved by a motor vehicle drive unit as disclosed herein, in conjunction with the characterizing features thereof. Further advantageous developments of the invention will be apparent from the present disclosure. An electrically drivable motor vehicle drive axle having a motor vehicle drive unit according to the invention is also disclosed.

According to the invention, a motor vehicle drive unit comprises an electric machine and a transmission arranged downstream of the electric machine on the output side. In this context, a supply circuit is assigned to the electric machine and the transmission, in which the electric machine and the transmission may be jointly supplied with lubricant and/or coolant. This supply circuit comprises a first collecting region and a second collecting region, of which a suction side of a conveying device opens into the first collecting region, via which lubricant and/or coolant is withdrawable from the first collecting region for supply to the electric machine and the transmission. The motor vehicle drive unit according to the invention is, in particular, provided for use in an electrically drivable motor vehicle drive axle.

According to the invention, the motor vehicle drive unit comprises an electric machine that is connected on the output side to a downstream transmission. In this context, the transmission is, in particular, provided to couple the electric machine on the output side to at least one output of the motor vehicle drive unit, wherein the transmission, in this coupling, more preferably effects a transmission ratio for drive movements between the electric machine and the at least one output. More preferably, two outputs are provided, to which, when the motor vehicle drive unit according to the invention is used in a motor vehicle drive axle, a connection to a respective wheel carrier, in particular, is established.

Within the scope of the invention, a “transmission” is thus understood to mean a mechanical chain along which a mechanical coupling of the electric machine to the at least one output is established or may be established. Thus, the transmission may also have a shifting capability in order, where appropriate, also to decouple the electric machine selectively from the at least one output. Within the scope of the invention, the transmission may comprise a gear set having selectable transmission ratios and/or comprise a differential gear set in order to be able to achieve a division of a drive movement to the preferably provided two outputs.

The electric machine comprises, in particular, in a manner known in principle to a person skilled in the art, a stator and a rotor, wherein the electric machine is preferably operable, on the one hand, as an electric motor and, on the other hand, as a generator. In principle, the electric machine may be configured as a permanently excited or externally excited synchronous machine or also as an asynchronous machine. Within the scope of the invention, it is also conceivable that the motor vehicle drive unit comprises, in addition to the electric machine, a further electric machine, which is then preferably likewise integrated via the transmission or is integrable. More preferably, exactly one electric machine is provided in the motor vehicle drive unit.

In the motor vehicle drive unit according to the invention, the electric machine and the transmission are integrated into a common supply circuit, in which the electric machine and the transmission are supplied with lubricant and/or coolant in operation of the motor vehicle drive unit. The lubricant and/or coolant is, in particular, a liquid lubricant and/or coolant and, more preferably, oil, wherein this liquid is, in particular, used both for lubrication and for cooling.

The lubricant and/or coolant is, in operation of the motor vehicle drive unit, in particular, circulated in the supply circuit and is thereby supplied to the transmission and the electric machine, wherein, in this case, in the electric machine, preferably a rotor cooling and a stator cooling and, if applicable, bearing points, and, in the transmission, in particular, mechanical regions, such as, for example, gear meshes and bearing points, are supplied. For supplying the lubricant and/or coolant to the electric machine and the transmission, a conveying device is provided in the supply circuit, which, in operation of the motor vehicle drive unit, conveys the lubricant and/or coolant in the direction of the regions to be supplied.

According to the invention, the supply circuit is equipped with collecting regions, which each preferably serve for collecting and accumulating lubricant and/or coolant. In particular, each collecting region defines a volume in which lubricant and/or coolant is collected and accumulated. In the case of a first of these collecting regions, a suction side of the conveying device additionally opens, such that the conveying device may withdraw the lubricant and/or coolant there for supply to the electric machine and the transmission.

The invention comprises the technical teaching that the first collecting region is arranged below the transmission in a direction of gravity and, in operation of the motor vehicle drive unit, collects at least one partial return flow in the supply circuit, with which lubricant and/or coolant flows off after supply from the transmission. Moreover, the second collecting region is arranged below the electric machine in a direction of gravity and above the first collecting region and, in operation of the motor vehicle drive unit, collects at least one partial return flow in the supply circuit, with which lubricant and/or coolant flows off after being supplied to the electric machine. The second collecting region is connected to the first collecting region, whereby lubricant and/or coolant may be discharged from the second collecting region into the first collecting region.

In other words, the first collecting region is located vertically below the transmission and is provided for collecting and accumulating at least one partial return flow, with which the lubricant and/or coolant flows off from the transmission in operation of the motor vehicle drive unit following a respective supply. Furthermore, the second collecting region is configured vertically below the electric machine and vertically above the first collecting region, wherein the second collecting region serves for accumulating at least one partial return flow, with which the lubricant and/or coolant flows off from the electric machine in operation of the motor vehicle drive unit following a supply. Furthermore, the second collecting region is connected to the first collecting region, such that discharge of lubricant and/or coolant from the second collecting region into the first collecting region may be achieved.

The configuration of a motor vehicle drive unit according to the invention has the advantage that, on the one hand, a compact construction is achieved. This is because the first collecting region arranged, in the direction of gravity, below the transmission may be positioned vertically closer to the transmission without components of the transmission immersing in the lubricant and/or coolant collected therein during operation of the motor vehicle drive unit. The reason for this is that the second collecting region functions as a buffer volume, in which the lubricant and/or coolant flowing off from the electric machine in operation of the motor vehicle drive unit is collected and is only subsequently discharged in the direction of the first collecting region. Instead of a common collecting region for collecting lubricant and/or coolant flowing off from the transmission and the electric machine, a division into two collecting regions is thus performed according to the invention, wherein withdrawal via the conveying device also takes place from the first collecting region. Since the second collecting region is additionally arranged above the first collecting region in the direction of gravity and thus vertically, the discharge of lubricant and/or coolant into the first collecting region may additionally be configured without a pump, which simplifies the construction of the motor vehicle drive unit and thereby also reduces the manufacturing effort thereof.

According to the invention, the first collecting region collects at least one partial return flow of lubricant and/or coolant flowing off from the transmission. More preferably, the first collecting region serves for directly collecting all lubricant and/or coolant flowing off from the transmission, wherein, in this context, a plurality of partial return flows may converge in the first collecting region. In particular, the first collecting region overlaps horizontally with at least one region of the transmission.

Furthermore, the first collecting region also serves for collecting the lubricant and/or coolant discharged from the second collecting region into the first collecting region, for which purpose the first collecting region is arranged below the second collecting region in a direction of gravity. The second collecting region is provided for directly collecting at least one partial return flow of lubricant and/or coolant flowing off from the electric machine, wherein the second collecting region, in this context, in particular, collects all lubricant and/or coolant flowing off from the electric machine. In this context, a plurality of partial return flows may converge in the second collecting region.

In particular, the second collecting region is connected to the first collecting region via at least one line via which discharge of the lubricant and/or coolant from the second collecting region into the first collecting region may be achieved. Alternatively, but preferably additionally, the discharge of the lubricant and/or coolant from the second collecting region into the first collecting region takes place under the effect of gravity. Within the scope of the invention, a “line” is preferably to be understood as a volume for guiding lubricant and/or coolant between respectively associated connection points. In this context, the respective line may be composed of a plurality of sections. Moreover, the respective line may be formed entirely by a pipe, entirely by a channel defined by a surrounding component, such as a housing, or in sections by one or more pipes and in sections by one or more channels.

If, in the motor vehicle drive unit according to the invention, at least one further electric machine is provided in addition to the electric machine, the second collecting region may also be arranged, in the direction of gravity, below this at least one further electric machine and collect at least one partial return flow, with which lubricant and/or coolant flows off after being supplied from the at least one further electric machine. Within the scope of the invention, at least one further electric machine may also be assigned a separate further collecting region, which is then arranged below the at least one further electric machine in a direction of gravity and above the first collecting region. This separate further collecting region may then generally be connected to the first collecting region in an analogous manner to the second collecting region.

According to one embodiment of the invention, the second collecting region is arranged so as to overlap with the electric machine in a horizontal direction. As a result, a compact placement of the second collecting region and, moreover, reliable collection of the at least one partial return flow flowing off from the electric machine may be achieved. Preferably, the second collecting region is additionally arranged between the electric machine and a part of the transmission in a direction of gravity, wherein the second collecting region overlaps horizontally with the electric machine and this part of the transmission. It is a particularly preferred development of the aforementioned embodiment that the second collecting region is arranged in a horizontal direction so as to lie next to a region of the transmission, in particular a differential gear set. This is because a suitable installation space for accommodating the second collecting region is available in this region.

According to an embodiment of the invention, a discharge line extends between the second collecting region and the first collecting region, which connects the first collecting region and the second collecting region to one another and permits a continuous discharge from the second collecting region into the first collecting region. This has the advantage that, via this discharge line, a continuous return of lubricant and/or coolant from the second collecting region into the first collecting region is achieved, from which a withdrawal via the conveying device is then subsequently carried out. In this context, the second collecting region serves, in operation of the motor vehicle drive unit, for buffering a specific volume of lubricant and/or coolant.

In a development of the invention, the discharge line has a line cross section such that a volumetric flow is established in the case of continuous discharge from the second collecting region into the first collecting region, wherein this volumetric flow is selected for setting a defined level of lubricant and/or coolant in the first collecting region in operation of the motor vehicle drive unit. In an advantageous manner, this enables a continuous outflow in the direction of the first collecting region via the discharge line, while, due to the defined line cross section, a throttling point is, as it were, formed, which ensures the setting of the desired level in the first collecting region in operation of the motor vehicle drive unit. Preferably, the discharge line has a constriction of its cross section, wherein this constriction may be configured in a region of an opening at the first collecting region, in a region of an opening at the second collecting region, or in an intermediate section of the discharge line.

Most preferably, at least one rotatable transmission element of the transmission protrudes into the first collecting region, wherein the level is defined such that the level lies below the protruding transmission element at least in operation of the motor vehicle drive unit. As a result, splashing of the at least one transmission element in lubricant and/or coolant is prevented at least in the course of operation of the motor vehicle drive unit, in that, due to the configuration of the discharge line with the line cross section and the associated definition of the level, immersion of the at least one transmission element in the lubricant and/or coolant collected in the first collecting region is avoided. Due to the protrusion of the at least one transmission element into the first collecting region, the first collecting region may be arranged vertically close to the transmission, and a particularly compact construction of the motor vehicle drive unit may thereby be achieved. In particular, the level is established upon start-up of the motor vehicle drive unit and with the commencement of a withdrawal of lubricant and/or coolant from the first collecting region via the conveying device.

In a further embodiment according to the invention, it is a conceivable variant that the discharge line opens at a bottom of the second collecting region, wherein this opening is implemented, in particular, at a region of this bottom that is lowest in the direction of gravity. As a result, upon termination of operation of the motor vehicle drive unit, complete emptying via the discharge line into the first collecting region is ensured.

It is a further embodiment of the invention that, in the case of the second collecting region, a first subregion is separated from a second subregion by a partition wall that forms an overflow between the subregions, wherein the first subregion of the second collecting region collects the at least one partial return flow from the electric machine and at least the second subregion of the second collecting region is connected to the first collecting region. This has the advantage that, by means of the overflow and the connection of the second subregion to the first collecting region, a return of lubricant and/or coolant from the second collecting region into the first collecting region takes place at least when the lubricant and/or coolant in the second collecting region reaches a level lying above the overflow.

Preferably, however, the aforementioned embodiment is combined with one of the variants of the preceding possible configuration, whereby a continuous return from the first subregion of the second collecting region into the first collecting region takes place and this return is then further increased upon exceeding the overflow. Thus, particularly suitable return into the first collecting region may be achieved.

In a development of the aforementioned embodiment, the second subregion of the second collecting region is connected to the first collecting region via a return line, which permits a continuous discharge from the second subregion of the second collecting region into the first collecting region. This has the advantage that, upon exceeding the overflow defined between the subregions, a reliable return into the first collecting region is achieved by means of the return line.

According to a further possible configuration according to the invention, the conveying device comprises a delivery pump, which is connected on the suction side to the first collecting region and is in connection on the pressure side with supply lines, via which supply to regions of the electric machine and the transmission to be supplied may occur. As a result, a suitable construction of the conveying device may be achieved, wherein, in this context, preferably exactly one delivery pump is provided. On a suction side, this delivery pump is, in particular, connected to the first collecting region via an intermediate suction filter and a suction line.

In a development of the aforementioned embodiment, the delivery pump is connected on the pressure side to a main supply line, which branches into the supply lines. In this context, a heat exchanger and/or a filter device is preferably arranged in the main supply line. By means of a heat exchanger, a temperature of the lubricant and/or coolant may be reliably reduced following a withdrawal from the first collecting region.

An arrangement of a filter device in the main supply line has the advantage that undesired particles may thereby be reliably separated from the lubricant and/or coolant.

Alternatively, but preferably additionally to one of the aforementioned developments, one of the supply lines ends at a stator cooling of a stator of the electric machine and/or one of the supply lines ends at a rotor cooling of a rotor of the electric machine and/or at least one of the supply lines ends at a respective gear mesh of the transmission. In particular, a plurality of the aforementioned supply lines is implemented, whereby suitable supply of regions of the electric machine and of the transmission takes place.

The invention further relates to an electrically drivable motor vehicle drive axle, which comprises a motor vehicle drive unit according to one or more of the variants described above. In this context, the motor vehicle drive axle may be an axle for a commercial vehicle.

### BRIEF DESCRIPTION OF THE DRAWINGS

An advantageous embodiment of the invention, which is explained below, is shown in the drawings. It shows:

FIGS. 1 and 2 show different views of a motor vehicle drive unit according to a preferred embodiment of the invention.

### DETAILED DESCRIPTION

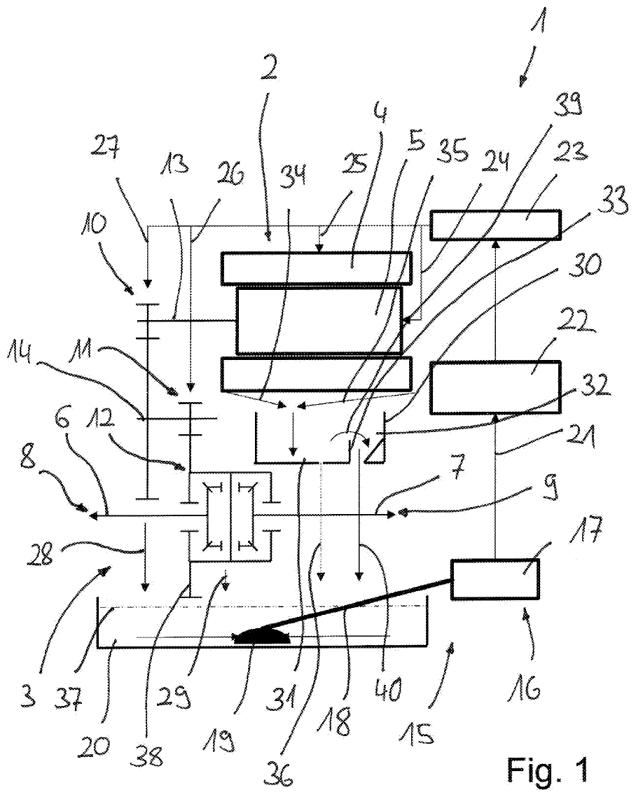

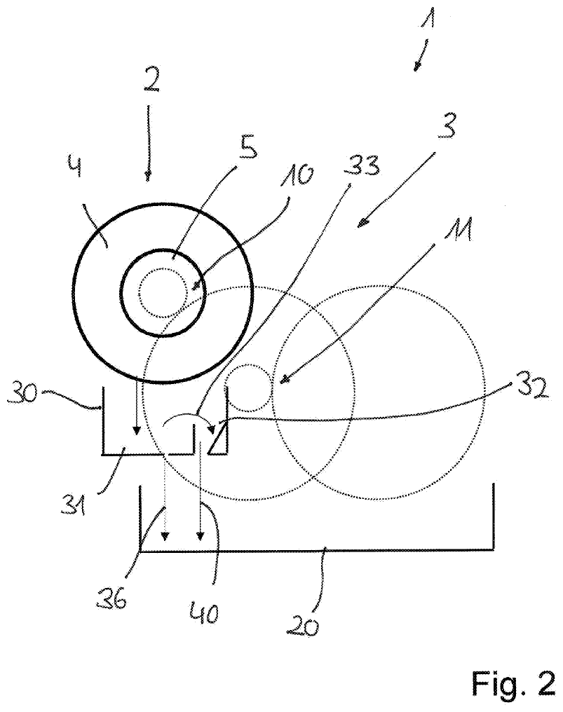

FIGS. 1 and 2 show different views of a motor vehicle drive unit 1, which is configured according to a preferred embodiment of the invention and is provided for use in an electrically drivable motor vehicle drive axle. The motor vehicle drive unit 1 comprises an electric machine 2 and a transmission 3, wherein the electric machine 2 is formed by a stator 4 and a rotor 5 and may be configured as a permanently excited or externally excited synchronous machine or as an asynchronous machine. Moreover, the electric machine 2 may be operated, on the one hand, as an electric motor and, on the other hand, as a generator.

The transmission 3 is arranged downstream of the electric machine 2 on the output side and couples the electric machine 2 to two output shafts 6 and 7, which each form a respective output 8 and 9 of the motor vehicle drive unit 1 and, when the motor vehicle drive unit 1 is used in an electrically drivable motor vehicle drive axle, lead, in particular, to a respective wheel carrier. The transmission 3 comprises two spur gear stages 10 and 11 and a differential gear set 12, which is configured here as a bevel gear differential. The spur gear stage 10 couples a rotor shaft 13 connected to the rotor 5 to a countershaft 14 arranged with an axis offset, which in turn is coupled via the spur gear stage 11 to an input side of the differential gear set 12. In electric motor operation of the electric machine 2, a drive movement of the electric machine 2 is thereby transmitted via the two spur gear stages 10 and 11 to the input side of the differential gear set 12, which subsequently splits the drive movement to the two output shafts 6 and 7.

For lubrication and cooling, the electric machine 2 and the transmission 3 are jointly integrated in the motor vehicle drive unit 1 into a supply circuit 15, in which lubricant and coolant are selectively supplied to regions of the electric machine 2 and the transmission 3 to be supplied. The lubricant and coolant is a fluid in the form of oil. The supply circuit 15 comprises a conveying device 16 having a delivery pump 17, to which a suction line 18 is connected on the suction side. The suction line 18 connects the delivery pump 17 to a suction device 19, via which the delivery pump 17 may draw lubricant and coolant from a collecting region 20. In particular, the suction device 19 is equipped with a screen in order to prevent larger particles from being sucked into the delivery pump 17.

Connected on the pressure side to the delivery pump 17 is a main supply line 21 in which first a heat exchanger 22 and, further along, a filter device 23 are arranged before the main supply line 21 branches into a plurality of supply lines 24, 25, 26, and 27. The supply lines 24 to 27 lead to the respective regions of the electric machine 2 and the transmission 3 to be supplied, wherein the supply line 24 leads specifically to a rotor cooling of the rotor 5, the supply line 25 to a stator cooling of the stator 4, and the supply lines 26 and 27 to the gear meshes of the spur gear stages 10 and 11 and further also to the differential gear set 12.

The collecting region 20 is arranged, in the direction of gravity, below the transmission 3 and so as to horizontally overlap with the transmission, wherein the collecting region 20 collects partial return flows 28 and 29 of lubricant and coolant, which, after being supplied via the supply lines 26 and 27, flow from the transmission 3 downward in the vertical direction due to gravity. In contrast, the lubricant and coolant supplied to the electric machine 2 via the supply lines 24 and 25 is collected by a collecting region 30, which is arranged, in the direction of gravity, below the electric machine 2 and so as to horizontally overlap therewith. The collecting region 30 is arranged above the collecting region 20 and, in the horizontal direction, as can be seen, in particular, in FIG. 2, next to the differential gear set 12 and the output shaft 7.

As can be seen in each case in FIG. 1 and also in FIG. 2, the collecting region 30 is divided into two subregions 31 and 32 in that the two subregions 31 and 32 are separated from one another by an intermediate partition wall 33. In the subregion 31, partial return flows 34 and 35 are collected, with which the lubricant and coolant supplied to the electric machine 2 via the supply lines 24 and 25 flows downward in the vertical direction under the influence of gravity, wherein the partial return flows 34 and 35 are combined for this purpose. In particular, in the supply circuit 15, the partial return flows 28, 29, 34, and 35 are discharged via respective associated return lines.

The collecting region 30 is connected to the collecting region 20 arranged below in the direction of gravity, on the one hand, via a discharge line 36, which opens, on the side of the collecting region 30, into a region of a bottom of the subregion 31 that is lowest in the direction of gravity and enables a continuous discharge of lubricant and coolant from the subregion 31 into the collecting region 20. The discharge line 36 is configured with a line cross section such that a defined volumetric flow is established in the case of continuous discharge. This volumetric flow ensures that, in operation of the motor vehicle drive unit 1 and the associated withdrawal of lubricant and coolant from the collecting region 20 via the delivery pump 17, a level 37 indicated in FIG. 1 is established in the collecting region 20. At this level 37, a gear 38, which protrudes into the collecting region 20 in the spur gear stage 11 of the transmission 3, does not immerse in the lubricant and coolant collected therein, whereby splashing of the gear 38 in the lubricant and coolant is prevented. The line cross section required for setting the level 37 is preferably implemented in the discharge line 36 by way of a throttle point, which is not shown here.

In the collecting region 30, the partition wall 33 additionally forms an overflow 39, via which lubricant and coolant may pass, upon reaching this level in the collecting region 30, from the subregion 31 into the subregion 32. The subregion 32 is likewise connected to the collecting region 20 in that a return line 40 extends between the subregion 32 and the collecting region 20. Via this return line 40, lubricant and coolant collected in the subregion 32 may flow out into the collecting region 20. As a consequence, upon exceeding the level in the collecting region 30 defined by the overflow 39, simultaneous discharge of lubricant and coolant via the discharge line 36 and the return line 40 occurs.

By means of the configuration according to the invention, a motor vehicle drive unit may be provided in which, with a compact construction and with the lowest possible manufacturing effort, a reliable supply of an electric machine and a transmission with lubricant and coolant in a supply circuit is achieved.

### REFERENCE SIGNS

1 motor vehicle drive unit
2 electric machine
3 transmission
4 stator
5 rotor
6 output shaft
7 output shaft
8 output
9 output
10 spur gear stage
11 spur gear stage
12 differential gear set
13 rotor shaft
14 countershaft
15 supply circuit
16 conveying device
17 delivery pump
18 suction line
19 suction device
20 collecting region
21 main supply line
22 heat exchanger
23 filter device
24 supply line
25 supply line
26 supply line
27 supply line
28 partial return flow
29 partial return flow
30 collecting region
31 subregion
32 subregion
33 partition wall
34 partial return flow
35 partial return flow
36 discharge line
37 level
38 gear
39 overflow
40 return line

1. A motor vehicle drive unit (1) for an electrically drivable motor vehicle drive axle, comprising:
an electric machine (2) having an output side;
a transmission (3) arranged downstream of the output side of the electric machine (2); and
a supply circuit (15) assigned to the electric machine (2) and the transmission (3), in which the electric machine (2) and the transmission (3) are jointly suppliable with lubricant and/or coolant;
wherein the supply circuit (15) comprises a first collecting region (20) and a second collecting region (30), of which, in the first collecting region (20), a suction side of a conveying device (16) opens, via which lubricant and/or coolant is withdrawable from the first collecting region (20) for supply to the electric machine (2) and the transmission (3);
wherein the first collecting region (20) is arranged, in a direction of gravity, below the transmission (3) and, in operation of the motor vehicle drive unit (1), is arranged to collect in the supply circuit (15) at least one partial return flow (28, 29), with which lubricant and/or coolant flows off after being supplied from the transmission (3);
wherein the second collecting region (30) is arranged, in the direction of gravity, below the electric machine (2) and above the first collecting region (20) and, in operation of the motor vehicle drive unit (1), is arranged to collect in the supply circuit (15) at least one partial return flow (34, 35), with which lubricant and/or coolant flows off after being supplied from the electric machine (2); and
wherein the second collecting region (30) is connected to the first collecting region (20), whereby lubricant and/or coolant is dischargeable from the second collecting region (30) into the first collecting region (20).

2. The motor vehicle drive unit (1) according to claim 1, wherein the second collecting region (30) is arranged so as to horizontally overlap with the electric machine (2).

3. The motor vehicle drive unit (1) according to claim 2, wherein the second collecting region (30) is arranged, in the horizontal direction, next to a differential gear set (12) of the transmission.

4. The motor vehicle drive unit (1) according to claim 1, comprising:
a discharge line (36) extending between the second collecting region (30) and the first collecting region (20), wherein the discharge line connects the first collecting region (20) to the second collecting region (30) and permits a continuous discharge from the second collecting region (30) into the first collecting region (20).

5. The motor vehicle drive unit (1) according to claim 4, wherein the discharge line (36) has a line cross section such that a volumetric flow is established in the case of continuous discharge from the second collecting region (30) into the first collecting region (20), wherein the volumetric flow is selected for setting a defined level (37) of lubricant and/or coolant in the first collecting region (20) in operation of the motor vehicle drive unit (1).

6. The motor vehicle drive unit (1) according to claim 5, wherein at least one rotatable transmission element of the transmission (3) protrudes into the first collecting region (20), wherein a level (37) is defined such that the level (37) lies below the protruding transmission element at least in operation of the motor vehicle drive unit (1).

7. The motor vehicle drive unit (1) according to claim 4, wherein the discharge line (36) opens at a bottom of the second collecting region (30), wherein the bottom is lowest in the direction of gravity.

8. The motor vehicle drive unit according to claim 1, comprising.
a partition wall (33) in the second collecting region (30), the partition wall separating a first subregion (31) from a second subregion (32),
wherein the partition wall forms an overflow (39) between the first and second subregions (31, 32),
wherein the first subregion (31) is arranged to collect the at least one partial return flow (34, 35) from the electric machine (2); and
wherein at least the second subregion (32) is connected to the first collecting region (20).

9. The motor vehicle drive unit (1) according to claim 8, comprising a return line, wherein the second subregion (32) of the second collecting region (30) is connected to the first collecting region (20) via the return line (40), and wherein the return line permits a continuous discharge from the second subregion (32) of the second collecting region (30) into the first collecting region (20).

10. The motor vehicle drive unit (1) according to claim 1, wherein the conveying device (16) comprises a delivery pump (17) connected on a suction side to the first collecting region (20) and is in connection on a pressure side with supply lines (24, 25, 26, 27), via which supply to regions of the electric machine (2) and the transmission (3) to be supplied is respectively achievable.

11. The motor vehicle drive unit (1) according to claim 10, wherein the delivery pump (17) is connected on the pressure side to a main supply line (21), which branches into the supply lines (24, 25, 26, 27).

12. The motor vehicle drive unit (1) according to claim 11, comprising a heat exchanger (22) and/or a filter device (23) arranged in the main supply line (21).

13. The motor vehicle drive unit (1) according to claim 10, wherein one supply line (25) of the supply lines (24, 25, 26 27) ends at a stator cooling of a stator (4) of the electric machine (2) and/or one supply line (24) ends at a rotor cooling of a rotor (5) of the electric machine (2) and/or at least one supply line (26, 27) ends at a respective gear mesh of the transmission (3).

14. An electrically drivable motor vehicle drive axle, comprising the motor vehicle drive unit (1) according to claim 1.
